(19) United States
(12) Patent Application Publication
(10) Pub. No.: US 2007/0120393 A1
(43) Pub. Date: May 31, 2007

(54) Security door frame for recreational vehicles

(75) Inventor: Kerry Jackson, Helensvale (AU)

Correspondence Address: BROOKS KUSHMAN P.C., 1000 TOWN CENTER, TWENTY-SECOND FLOOR, SOUTHFIELD, MI, 48075, US

(73) Assignee: Roam Safe PTY LTD, Helensvale, QLD (AU)

(21) Appl. No.: 10/595,655

(22) PCT Filed: Nov. 3, 2004
(86) PCT No.: PCT/AU04/01519

§ 371 Date: May 3, 2006

(30) Foreign Application Priority Data
Nov. 3, 2003 (AU) 2003906042

(51) Int. Cl. B60J 5/00

(52) U.S. Cl. 296/146.6

(57) ABSTRACT

A security door frame for recreational vehicles including a hollow main frame portion comprising a main wall surrounding an internal bore, the main wall including a latch assembly mounting face for mounting a latch assembly thereto such that at least part of the latch assembly can extend into the internal bore; an architrave lapping portion attached to and extending from the main wall of the main frame portion adjacent the latch assembly mounting face and having an architrave lapping face for lapping an architrave and a hinge mounting face substantially parallel to the architrave lapping face; and a screen mounting portion attached to and extending from the main wall of the main frame portion remote from the architrave lapping portion, the screen mounting portion having a screen spline channel adapted for receiving a screen mounting spline; the parts being so formed and arranged that a screen panel when mounted to the screen mounting portion is spaced from the hinge mounting face a distance sufficient to receive door furniture of a door when closed against the hinge mounting face of the architrave lapping portion.

### FIELD OF INVENTION

THIS INVENTION relates to a security door frame for recreational vehicles. The invention has particular application to security door frames for mobile homes and caravans. However, the invention is not limited to this field of use.

### BACKGROUND ART

Mobile homes and caravans often have a single main access doorway provided with a main door to close the opening with a solid panel. Screen doors are sometimes fitted on mobile homes but usually provide little, if any, protection against unauthorised intrusion, and are prone to damage through accidental collision with the screen panel. In order to address the safety and security issues, expanded metal grilles have been provided with the screen panel mounted into the same frame as the grille. However, such arrangements can be bulky. Sometimes, such arrangements do not provide for the easy operation of door opening mechanisms for the main door.

The present invention aims to provide a security door frame to which a secure screen door may be mounted which alleviates one or more of the problems of the prior art, or at least provides an alternative to existing arrangements. Other aims and advantages of the invention may become apparent from the following description.

### DISCLOSURE OF THE INVENTION

With the foregoing in view, this invention in one aspect resides broadly in a security door frame for recreational vehicles including:

a hollow main frame portion comprising a main wall surrounding an internal bore, the main wall including a latch assembly mounting face for mounting a latch assembly thereto such that at least part of the latch assembly can extend into the internal bore;

an architrave lapping portion attached to and extending from the main wall of the main frame portion adjacent the latch assembly mounting face and having an architrave lapping face for lapping an architrave and a hinge mounting face substantially parallel to the architrave lapping face; and

a screen mounting portion attached to and extending from the main wall of the main frame portion remote from the architrave lapping portion, the screen mounting portion having a screen spline channel adapted for receiving a screen mounting spline;

the parts being so formed and arranged that a screen panel when mounted to the screen mounting portion is spaced from the hinge mounting face a distance sufficient to receive door furniture of a door when closed against the hinge mounting face of the architrave lapping portion.

In another aspect, the present invention resides broadly in an extrusion for a security door frame for recreational vehicles including:

a hollow main frame portion comprising a main wall surrounding an internal bore, the main wall including a latch assembly mounting face for mounting a latch assembly thereto such that at least part of the latch assembly can extend into the internal bore;

an architrave lapping portion attached to and extending from the main wall of the main frame portion adjacent the latch assembly mounting face and having an architrave lapping face for lapping an architrave and a hinge mounting face substantially parallel to the architrave lapping face; and

a screen mounting portion attached to and extending from the main wall of the main frame portion remote from the architrave lapping portion, the screen mounting portion having a screen spline channel adapted for receiving a screen mounting spline;

the parts being so formed and arranged that when formed into a frame having two stiles spaced from one another and two rails connecting the ends of the stiles to form a security door frame surrounding a screen space, a screen panel when mounted to the screen mounting portion to span the screen mounting space is spaced from the hinge mounting face a distance sufficient to receive door furniture of a door when closed against the hinge mounting face of the architrave lapping portion.

In another aspect, the present invention resides broadly in a security door for recreational vehicles including:

a security door frame having two stile members and two rail members joining the ends of the stile members together to form a rectangular door frame, the stile and rail members being formed from an extrusion for a security door frame as hereinbefore described, the corners of the door frame being formed from joining elements having spigots adapted for insertion into the internal bore of the main frame portion;

a door latch assembly mounted to the latch assembly mounting face of the main frame portion;

one or more hinges mounted to the hinge mounting face of the architrave lapping portion; and

a screen panel mounted to the screen mounting portion by operative insertion of a screen mounting spline into the screen spline channel to hold an edge portion of the screen panel therein.

Preferably, the door also includes a security grille mounted to a security grille mounting channel as hereinbefore described. Preferably, architrave lapping face includes a seal channel for receiving a sealing strip.

In another aspect, the present invention resides broadly in a section of an extrusion for a security door frame for recreational vehicles including:

a hollow rectangle wherein the longer sides comprise an closing side spaced from an opening side, and the shorter sides comprise an inner side spaced from an outer side, the inner side adjoining the closing and opening sides at their respective ends substantially at right angles and the outer side joining the closing and opening sides inward from their respective ends substantially at right angles;

an L-shaped hollow portion having six sides, (1) one side being a common side common to a portion of the opening side of the rectangle from its outer end to (2) an inner web side extending from the opening side of the rectangle substantially at right angles to intersect at its end with (3) an outer flange side substantially at right angles outwardly to (4) an outward side remote extending substantially at right angles from the end of the outer flange side towards the closing side of the rectangle to (5) an inner flange side extending substantially at right angles from the end of the outward side to meet substantially at right angles with (6) an outer web side extending from the outer distal end of the opening side of the rectangle.

a closing side extension extending substantially co-lineally with inner side of the rectangle from closing side the rectangle to terminate at a distal end; and

an inner end extension having a proximal leg and a distal leg, the proximal leg extending substantially at right angles from the inner side of the rectangle intermediate the closing and opening sides and the distal leg extending substantially at right angles from the end of the proximal leg to run substantially parallel to the closing side extension to end substantially level with the distal end of the closing side extension.

When extended to form an extrusion, the section suitably forms an extrusion for a security door as hereinbefore described. In such form, the outer side when extended forms a latch assembly mounting face for mounting a latch assembly as hereinbefore described. In such form, the inner flange side of the section when extended forms the latch assembly mounting face and the outer flange side forms the hinge mounting face as hereinbefore described.

Preferably, the screen mounting portion further includes a grille mounting channel into which a security grille may be received. Preferably, architrave lapping face includes a door seal channel for receiving a door seal. Suitably, door seals are in the form of a velour or mohair strip to provide sealing engagement of the lapping face against the complementary face of the architrave. The screen panel is suitably an insect screen or the like mounted to the screen mounting portion in the normal manner of inserting an edge portion of the screen panel in the screen spline channel and holding it in place by operative insertion of a screen spline, suitably in the form of an elastomeric flexible spline sized to provide an interference fit into the screen spline channel. Accordingly, the security door frame of the present invention may be pivotally mounted to a door architrave frame of a recreational vehicle for pivotal movement between a closed position at which the lapping face is in substantial mating contact with the door architrave frame and an open position pivoted away from the door architrave frame along the pivot axis of the hinge.

### BRIEF DESCRIPTION OF THE DRAWINGS

In order that the invention may be more readily understood and put into practical effect, reference will now be made to the accompanying drawings which illustrate preferred embodiments of the invention and wherein:

FIG. 1 is an oblique view of a sample length of an extrusion for a security door frame according to the invention;

FIG. 2 is a sectional view of an extrusion for an alternative security door frame according to the invention shown with part of a door in closed disposition in relation thereto;

FIGS. 3 and 4 are front and back elevations showing the opening and closing sides of a corner connector for use with the extrusions of FIG. 1 or FIG. 2;

FIGS. 5 and 6 are front and back elevations showing the opening and closing sides of a door formed having a door frame formed from an extrusion according to the invention.

### DETAILED DESCRIPTION OF THE DRAWINGS

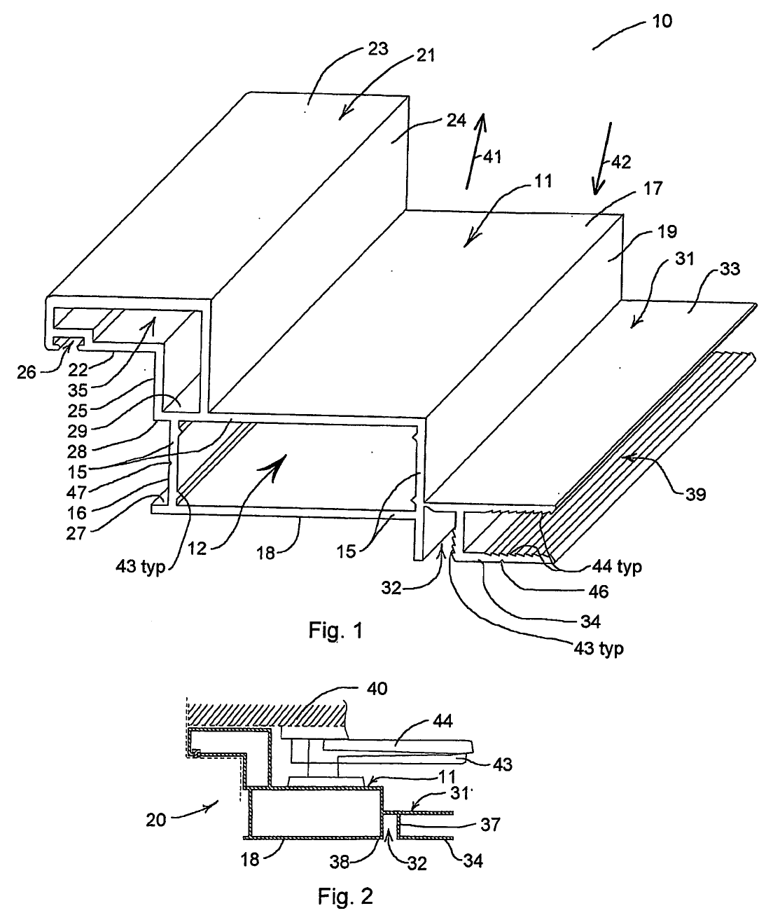

The security door frame extrusion 10 shown in FIG. 1 includes a hollow main frame portion 11, an architrave lapping portion 21 extending from one part of the main frame portion and a screen mounting portion 31 extending from a diametrically opposed part of the main frame portion.

The hollow main frame portion is substantially rectangular in form, having a main periphery 15 having four walls. The main periphery is formed from a latch assembly mounting wall 16 and opposite thereto an inner wall 19, and joining each side edge of the latch mounting wall and the inner wall, an opening wall 17 and spaced therefrom and parallel thereto a closing wall 18. Thus, the four walls having outer faces to which the same terms may be applied, namely, a latch mounting face, an inner face, an opening face and a closing face. Thus, the main periphery circumscribes a substantially rectangular internal bore 12 through the length of the security door frame extrusion. The latch assembly mounting face is formed inward from the side edges of the opening and closing faces to form a channel having a depth sufficient to accommodate the thickness of a mounting plate of a latch assembly (not shown), the opening and closing faces being formed to provide two side walls 27 and 28 to give depth to the channel.

The architrave lapping portion is L-shaped in form and, in similar fashion to the main frame portion, is formed as a hollow section having six walls. Extending at right angles from the opening face is an inner web wall 24, and at right angles thereto and extending away from the main frame portion is a hinge mounting wall 23. Extending outward and parallel to the inner web wall is an outer web wall 25 formed at right angles to the opening wall from its outer edge, and at right angles thereto and extending outward is an architrave lapping wall 22. A door seal channel 26 is provided in the outer face of the architrave lapping wall in the form of a T-shaped channel into which a door seal (not shown) can be received. It can be seen that an L-section bore 35 extends through the architrave lapping portion. Part of the opening face is a common wall 29 being common to the main frame portion and the architrave lapping portion.

The screen mounting portion includes a screen spline channel 32 having, as its base wall, part of an opening side flange 33 which extends beyond the screen spline channel to form one side of a grille mounting channel 39. The other side of the grille mounting channel is formed from a closing side flange 34 which extends at right angles from a spline channel inner wall opposed to a spline channel outer wall, the spline channel inner and outer walls being substantially the same width so that the closing face of the closing side flange is substantially level with the distal edge of the spline channel outer wall. The inside face of the spline channel inner wall includes a plurality of ribs being approximately barbed shaped in cross section for retaining a screen mounting spline (not shown) when inserted into the screen spline channel. In similar form, the internal faces of the opening and closing side flanges include a plurality of ribs of barbed shaped cross section for retaining a grille or the like in the grille mounting channel. The grille mounting channel is also sized to accommodate secure insect screening if desired. The closing face of the closing side flange also includes a grille fastener locating groove 46 to assist in locating apertures to be drilled therethrough for securing a grill in the grill mounting channel such as by self tapping screw or a pop rivet, or self-drilling screws. In a similar fashion, a latch mounting groove 47 is provided down the middle of the latch assembly mounting face to assist in locating drill bits for drilling or screws or the like for mounting a latch assembly to the latch assembly mounting face. When forming a door frame as described herein, the security door frame extrusion may be pivoted about a hinge access to open generally in the direction of an opening arrow 41 or to close generally in the direction of a closing arrow 42. The alternative security door frame extrusion 20 shown in FIG. 2 is the same in most respects as that shown in FIG. 1 with the exception that the screen mounting portion 31 extends from the main frame portion at a location across the inner wall 19 such that the closing side flange 34 of the grille mounting channel (or when removed from the extrusion) the distal edge of the spline channel inner wall is about level with the closing face of the closing wall 18, the spline channel outer wall coinciding with part of the inner wall which terminate at a corner 38. Additionally, the alternative security door frame is shown with a portion of an external door 40 in closed disposition with respect thereto. The external door includes an external door handle 43 extending from its inner face and displaced above or below a security screen handle 44, that portion of the security door handle which vertically overlaps the respective external door handle being shown in dotted outline. It can be seen that the spacing between the screen panel is spaced from the hinge mounting face a distance sufficient to receive door furniture of a door when closed against the hinge mounting face of the architrave lapping portion.

Thus, the hinge mounting and inner web faces, opening and inner faces, together with the opening side flange opening side face provides a double step profile such that the opening face of the opening side flange is displaced in the direction of the closing arrow 42 from the hinge mounting face by the width of the respective inner web and inner faces, the combined width being selected to provide clearance of door furniture which when mounted to the frame of a recreation vehicle will be pivotal to close against the opening face of the hinge mounting face.

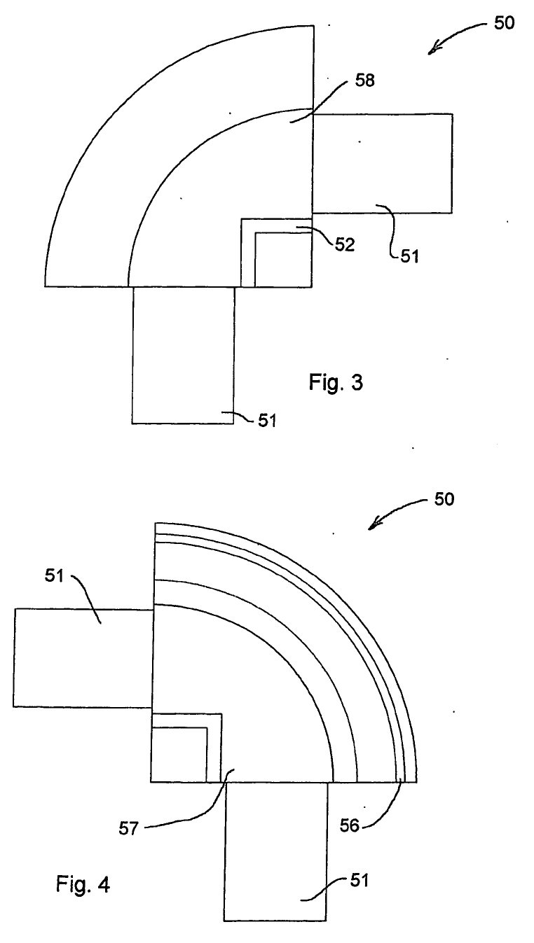

The corner connector 50 shown in FIGS. 3 and 4 has two spigots 51, each being at right angle to the other and sized to provide an inference fit in the rectangular internal bore of the main frame portion of the security frame extrusion. The internal bore includes four ribs shown typically at 45 to enable a tight fitting of the spigots in the internal bore. On the closing face 58 of the corner connector there is provided a screen spline channel 52 in the appropriate location to line up with the screen spline channel of the extrusion. On the opening face 57, there is provided a door seal channel 56 sized and disposed to line up with the door seal channel in the extrusion when the corner connector is operative inserted into the internal bore of the security door frame extrusion. Of course, alternative arrangements concerning the disposition of the screen spline channel with respect to the closing face are provided to accommodate the differences between the door frame extrusions shown in FIGS. 1 and 2.

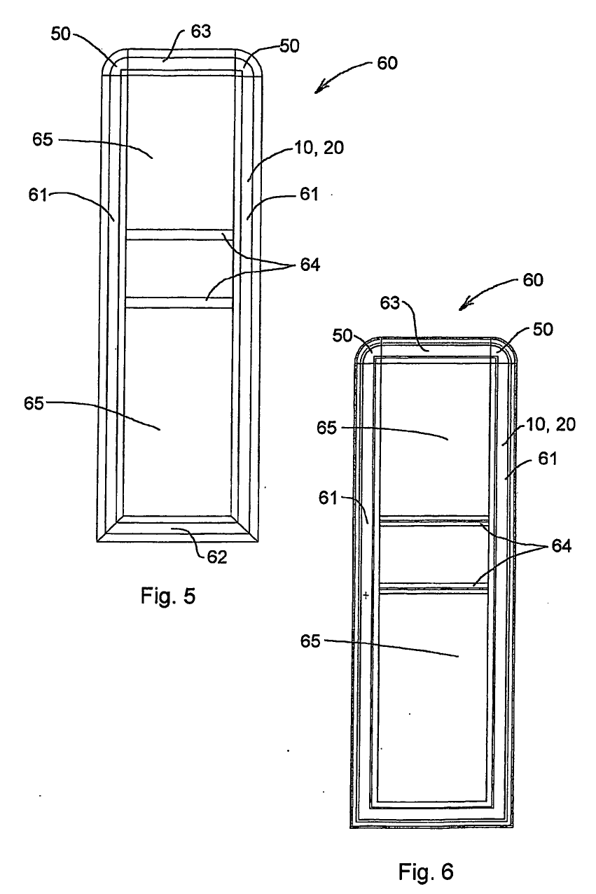

The security door 60 shown in FIGS. 5 and 6 is made up of two stiles 61 cut at 45 degrees at the bottom to form a mitred joint with a bottom rail 62 and cut square at the top to be joined to a top rail 63 using the corner connectors 50 described in respect of FIGS. 3 and 4. Two intermediate rails 64 extend parallel to the top and bottom rails intermediate the ends of the stiles, spaced apart from one another, and arranged to provide for an opening in a screen panel 65 to permit access to the door handle of a door which closes against the outer face, that is, the opening face, of the security door frame extrusion. Accordingly, the door shown in FIGS. 5 and 6 can be mounted to the door frame, architrave or door jam of a recreational vehicle and an outer door mounted thereto to close against the opening face thereof with clearance for the door furniture as herein before described. Sometimes, recreational vehicles will already have an insect screen or the like installed in which case the insect screen door can be removed and replaced by the security door according to the present invention.

Although the invention has been described with reference to a specific example, it will be appreciated by persons skilled in the art that the invention may be embodied in other forms which are encompassed within the broad scope and ambit of the invention as defined by the following claims.

1. A security door frame for recreational vehicles including:
a hollow main frame portion comprising a main wall surrounding an internal bore, the main wall including a latch assembly mounting face for mounting a latch assembly thereto such that at least part of the latch assembly can extend into the internal bore;
an architrave lapping portion attached to and extending from the main wall of the main frame portion adjacent the latch assembly mounting face and having an architrave lapping face for lapping an architrave and a hinge mounting face substantially parallel to the architrave lapping face; and
a screen mounting portion attached to and extending from the main wall of the main frame portion remote from the architrave lapping portion, the screen mounting portion having a screen spline channel adapted for receiving a screen mounting spline;
the parts being so formed and arranged that a screen panel when mounted to the screen mounting portion is spaced from the hinge mounting face a distance sufficient to receive door furniture of a door when closed against the hinge mounting face of the architrave lapping portion.

2. An extrusion for a security door frame for recreational vehicles including:
hollow main frame portion comprising a main wall surrounding an internal bore, the main wall including a latch assembly mounting face for mounting a latch assembly thereto such that at least part of the latch assembly can extend into the internal bore;
an architrave lapping portion attached to and extending from the main wall of the main frame portion adjacent the latch assembly mounting face and having an architrave lapping face for lapping an architrave and a hinge mounting face substantially parallel to the architrave lapping face; and
a screen mounting portion attached to and extending from the main wall of the main frame portion remote from the architrave lapping portion, the screen mounting portion having a screen spline channel adapted for receiving a screen mounting spline;
the parts being so formed and arranged that when formed into a frame having two stiles spaced from one another and two rails connecting the ends of the stiles to form a security door frame surrounding a screen space, a screen panel when mounted to the screen mounting portion to span the screen mounting space is spaced from the hinge mounting face a distance sufficient to receive door furniture of a door when closed against the hinge mounting face of the architrave lapping portion.

3. A security door for recreational vehicles including:
a security door frame having two stile members and two rail members joining the ends of the stile members together to form a rectangular door frame, the stile and rail members being formed from an extrusion for a security door frame as hereinbefore described, the corners of the door frame being formed from joining elements having spigots adapted for insertion into the internal bore of the main frame portion;
a door latch assembly mounted to the latch assembly mounting face of the main frame portion;
one or more hinges mounted to the hinge mounting face of the architrave lapping portion; and
a screen panel mounted to the screen mounting portion by operative insertion of a screen mounting spline into the screen spline channel to hold an edge portion of the screen panel therein.

4. A section of an extrusion for a security door frame for recreational vehicles including:
a hollow rectangle wherein the longer sides comprise an closing side spaced from an opening side, and the shorter sides comprise an inner side spaced from an outer side, the inner side adjoining the closing and opening sides at their respective ends substantially at right angles and the outer side joining the closing and opening sides inward from their respective ends substantially at right angles;
an L-shaped hollow portion having six sides, (1) one side being a common side common to a portion of the opening side of the rectangle from its outer end to (2) an inner web side extending from the opening side of the rectangle substantially at right angles to intersect at its end with (3) an outer flange side substantially at right angles outwardly to (4) an outward side remote extending substantially at right angles from the end of the outer flange side towards the closing side of the rectangle to (5) an inner flange side extending substantially at right angles from the end of the outward side to meet substantially at right angles with (6) an outer web side extending from the outer distal end of the opening side of the rectangle,
a closing side extension extending substantially co-lineally with inner side of the rectangle from closing side the rectangle to terminate at a distal end; and
an inner end extension having a proximal leg and a distal leg, the proximal leg extending substantially at right angles from the inner side of the rectangle intermediate the closing and opening sides and the distal leg extending substantially at right angles from the end of the proximal leg to run substantially parallel to the closing side extension to end substantially level with the distal end of the closing side extension.

5. The section according to claim 4, wherein, when extended to form an extrusion, said section forms an extrusion for a security door including
hollow main frame portion comprising a main wall surrounding an internal bore, the main wall including a latch assembly mounting face for mounting a latch assembly thereto such that at least part of the latch assembly can extend into the internal bore;
an architrave lapping portion attached to and extending from the main wall of the main frame portion adjacent the latch assembly mounting face and having an architrave lapping face for lapping an architrave and a hinge mounting face substantially parallel to the architrave lapping face; and
a screen mounting portion attached to and extending from the main wall of the main frame portion remote from the architrave lapping portion, the screen mounting portion having a screen spline channel adapted for receiving a screen mounting spline;
the parts being so formed and arranged that when formed into a frame having two stiles spaced from one another and two rails connecting the ends of the stiles to form a security door frame surrounding a screen space, a screen panel when mounted to the screen mounting portion to span the screen mounting space is spaced from the hinge mounting face a distance sufficient to receive door furniture of a door when closed against the hinge mounting face of the architrave lapping portion.

6. The section according to claim 5, wherein the outer side when extended forms a latch assembly mounting face for mounting a latch assembly.

7. The section according to claim 6, wherein the inner flange side of the section when extended forms the latch assembly mounting face and the outer flange side forms the hinge mounting face.

8. A section according to claim 7, wherein the screen mounting portion further includes a grille mounting channel into which a security grille may be received.
